(19) United States
(12) Patent Application Publication
(10) Pub. No.: US 2008/0246705 A1
(43) Pub. Date: Oct. 9, 2008

(54) OFF-STATE LIGHT RECAPTURING IN DISPLAY SYSTEMS EMPLOYING SPATIAL LIGHT MODULATORS

(75) Inventors: Andrew Ian Russell, Plano, TX (US); David Foster Lieb, Dallas, TX (US); Andrew Huibers, Sunnyvale, CA (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/696,044

(22) Filed: Apr. 3, 2007

(51) Int. Cl. G09G 3/32

(52) U.S. Cl. 345/82

(57) ABSTRACT

In display systems employing spatial light modulators, the OFF-state light from OFF-state pixels of the spatial light modulator can be captured and directed back to the pixels of the spatial light modulator so as to recycle the OFF-state light in the display system.

### CROSS REFERENCE TO RELATED APPLICATIONS

This US patent application is related to “A Pulse Width Modulation Algorithm,” attorney docket number TI-63236; and “A Pulse Width Modulation Algorithm,” attorney docket number TI-63237, both to Russell and filed on the same day as this patent application, the subject matter of each being incorporated herein by reference in its entirety.

### TECHNICAL FIELD

The technical field of the examples to be disclosed in the following sections relates to the art of display systems, and more particularly, to the field of display systems employing spatial light modulators.

### BACKGROUND

In current imaging systems that employ spatial light modulators composed of individually addressable pixels, a beam of incident light is directed to the pixels of the spatial light modulator. By setting the pixels at an ON state, the incident light is modulated onto a screen so as to generate bright image pixels on the screen, wherein such modulated light is referred to as the ON-state light; and the pixels at the ON state are referred to as ON-state pixels. By setting the pixels at an OFF state, the incident light is modulated away from the screen so as to cause dark pixels on the screen, wherein such modulated light is referred to as OFF-state light; and the pixels at the OFF state are referred to as OFF-state pixels. For obtaining a high contrast ratio, the OFF-state light is dumped or discarded by the imaging systems, which on the other hand, reduces the optical efficiency of the imaging system.

### SUMMARY

In one example, a method for use in a display system that employs a spatial light modulator is disclosed herein. The method comprises: directing a light beam to the pixels of the spatial light modulator; modulating the light beam into a first portion of light and a second portion of light by the spatial light modulator; directing the first portion onto a target and the second portion away from the target; and recycling the second portion of light back to the pixels of the spatial light modulator.

In another example, a display system is disclosed herein. The display system comprises: a light source capable of providing light; a spatial light modulator having an array of pixels for modulating the light into a first portion of light and a second portion of light such that the first portion of light can be directed to a display target by a projection lens, while the second portion of light is directed away from the display target; and an off-state recycling mechanism having a first portion that is optically coupled to a propagation path of the first portion of light from the spatial light modulator for capturing the second portion of light; and a second portion positioned such that the captured second portion of light is capable of being delivered back to the spatial light modulator.

In yet another example, a display system is disclosed herein. The display system comprises: an illumination system capable of providing a multiplicity of color light beams of different characteristic spectrums that fall in a plurality of visible color light ranges; a plurality of spatial light modulators each having an array of pixels capable of being operated at a first state and a second state; a plurality of optical elements capable of a) directing the color light beams onto the spatial light modulators such that at least two of the spatial light modulators are illuminated by the color light beams whose spectrums fall in different color ranges; and b) directing a first portion of light from the pixels at the first state onto a display target, and a second portion of light from the pixels at the second state away from the display target; and an off-state light recycling mechanism optically coupled to at least one of the plurality of spatial light modulators for recycling the second portion of light from the pixels of said at least one of the plurality of spatial light modulators back to said at least one of the plurality of spatial light modulators.

In still yet another example, a method for reproducing an image is disclosed herein. The method comprises: providing a plurality of light components having different characteristic spectrums that fall in a plurality of visible light ranges; directing the light components to a plurality of spatial light modulators such that at least two of the spatial light modulators are illuminated by color light beams whose spectrums fall in different color ranges, wherein each spatial light has an array of pixels capable of being operated at a first state and a second state; directing the light from the pixels at the first state onto a display target, and the light from the pixels at the second state away from the display target; and recycling the light from the pixels at the second state from at least one of the plurality of spatial light modulators back to said at least one of the plurality of spatial light modulators.

In yet another example, a display system is disclosed herein. The display system comprises: a light source comprising a solid-state light emitting device for providing a narrow-band light beam; a lightpipe optically coupled to the light source for directing the light beam to a spatial light modulator that is capable of modulating the light beam; and an optical element for projecting the modulated light onto a screen.

In yet another example, a device is disclosed herein. The device comprises: a lightpipe comprising an open end and a side wall at the other end, wherein the side wall comprises an opening having a characteristic dimension of 1 mm or less.

In yet another example, a method for producing an image is disclosed herein. The method comprises: providing a light beam; directing the light beam onto an array of micromirrors each having a reflective and movable mirror plate that is capable of being operated at first and second states such that the light beam is substantially perpendicularly incident to the mirror plate at the second state; modulating the light beam by the micromirrors such that the modulated light from the micromirrors at the first state is directed to a display target and the light from the micromirrors at the second state is away from the display target; and projecting the light from the micromirrors at the first state onto a screen.

### BRIEF DESCRIPTION OF DRAWINGS

FIG. 1 diagrammatically illustrates a diagram of an exemplary display comprising an off-state light recycling mechanism;

FIG. 2 is a block diagram illustrating an exemplary light source that can be used in the display system shown in FIG. 1;

FIG. 3 is a block diagram illustrating an exemplary off-state light recapturing mechanism in the display system shown in FIG. 1;

FIG. 4 is a block diagram illustrating another exemplary off-state light recapturing in the display system shown in FIG. 1;

FIG. 5 is a block diagram illustrating yet another exemplary off-state light recapturing in the display system shown in FIG. 1;

FIG. 6a and FIG. 6b schematically illustrate an exemplary optical arrangement of the incident light in relation to the operational states of the micromirrors of the display system shown in FIG. 1;

FIG. 7a and FIG. 7b schematically illustrate another exemplary optical arrangement of the incident light in relation to the operational states of the micromirrors of the display system shown in FIG. 1;

FIG. 8a and FIG. 8b schematically illustrate an exemplary optical arrangement of the incident light in relation to the operational states of the micromirrors of the display system shown in FIG. 1;

FIG. 9a to FIG. 9c illustrates the gap between adjacent micromirrors;

FIG. 10a schematically illustrates a minimum gap defined by two adjacent mirror plates that rotate symmetrically;

FIG. 10b schematically illustrates another minimum gap defined by two adjacent mirror plates that rotate symmetrically, wherein the distance between the mirror plate and the hinge is less than that in FIG. 10a;

FIG. 10c schematically illustrates yet another minimum gap defined by two adjacent mirror plates that rotate asymmetrically, wherein the distance between the mirror plate and the hinge is the same as that in FIG. 10b;

FIG. 11a is a cross-section view of two adjacent micromirrors illustrating the relative rotational positions of two adjacent mirror plates when one micromirror is at the OFF state and the other one at the ON state;

FIG. 11b and FIG. 11c schematically illustrate a cross-sectional view of a mirror plate of an exemplary micromirror having asymmetric rotation angles, wherein FIG. 11b illustrates the mirror plate at an ON state; and FIG. 11c illustrates the mirror plate at an OFF-state;

FIG. 12 schematically illustrates a perspective view of an exemplary micromirror that can be used in the spatial light modulator of the display system shown in FIG. 1;

FIG. 13 is a diagram illustrating another exemplary display system comprising an off-state light recycling mechanism;

FIG. 14 is a diagram illustrating yet another exemplary display system comprising an off-state light recycling mechanism;

FIG. 15 schematically illustrates yet another exemplary display system employing an off-state light recycling mechanism;

FIG. 16 shows a diagram of the maximum gain vs. recycling efficiency;

FIG. 17 shows a diagram of the gain vs. the average-picture-level (APL);

FIG. 18 shows a diagram of brightness boost profile; and

FIGS. 19a and 19b show exemplary images before and after the brightness boost.

### DETAILED DESCRIPTION OF SELECTED EXAMPLES

Disclosed herein is a method and a recycling mechanism for capturing off-state light from spatial light modulators in display systems and redirecting the recycled off-state light to the spatial light modulators. In the following, the method and the recycling mechanism will be discussed with reference to particular examples. It will be appreciated by those skilled in the art that the following discussion is for demonstration purpose, and should not be interpreted as a limitation. Other variations without departing from the spirit of this disclosure are also applicable.

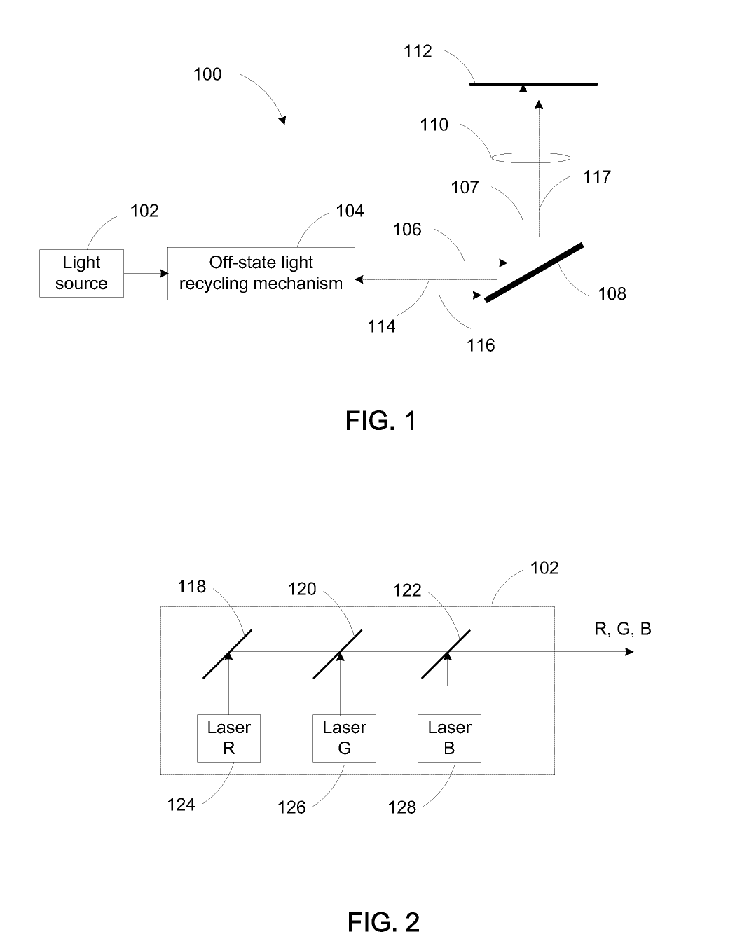

Referring to the drawings, FIG. 1 diagrammatically illustrates an exemplary display system in which an off-state recycling mechanism is implemented. In its basic structure, display system 100 comprises light source 102, off-state light recycling mechanism 104, spatial light modulator 108, projection lens 110, and display target 112. The display target can be a screen on a wall or the like, or it can be a member of a rear projection system, such as a rear projection television. In fact, the display system 100 can be any suitable display system, such as a front projector, a rear projection television, or a display unit for use in other systems, such as mobile telephones, personal data assistants (PDAs), hand-held or portable computers, camcorders, video game consoles, and other image displaying devices, such as electronic billboards and aesthetic structures.

Light source 102 provides light for the imaging system. The light source may comprise a wide range of light emitting devices, such as lasers, light-emitting-diodes, arc lamps, devices employing free space or waveguide-confined nonlinear optical conversion and many other light emitting devices. In particular, the light source can be a light source with a low etendue, such as solid state light emitting devices (e.g. lasers and light-emitting-diodes (LEDs)). When solid-state light emitting devices are used, the light source may comprise an array of solid-state light emitting devices capable of emitting different colors, such as colors selected from red, green, blue, and white. Because a single solid-state light emitting device generally has a narrow characteristic bandwidth that may not be optimal for use in display systems employing spatial light modulators, multiple solid-state light emitting devices can be used for providing light of each color so as to achieve optimal bandwidth for specific display systems. For example, multiple lasers or LEDs with slightly different characteristic spectra, such as 20 nm or less characteristic wavelength separation, can be used to produce a color light such that the characteristic spectra of the multiple lasers or LEDs together form an optimal spectrum profile of the display system. Exemplary laser sources are vertical cavity surface emitting lasers (VCSEL) and Novalux™ extended cavity surface emitting lasers (NECSEL), or any other suitable laser emitting devices. As a way of example, FIG. 2 schematically illustrates an exemplary light source of laser emitting devices.

Referring to FIG. 2, light source 102 comprises laser emitting devices laser R 124, laser G 126, and laser B 128 for emitting light of different colors, such as red, green, and blue colors. The laser light beams from laser emitting devices 124, 126, and 128 are combined and directed to the spatial light modulator through reflective mirror 118, optical filter 120 that passes the red light and reflects other color spectrums, and optical filter 122 that passes the red and green light components and reflects the blue light spectrum.

In other examples, the light source (102) may have any number of laser emitting devices capable of providing any suitable colors, preferably those colors selected from red, green, blue, yellow, magenta, cyan, white, or any combinations thereof. As afore mentioned, each light emitting device (124, 126, or 128) may be composed of multiple light emitting devices of slightly different characteristic spectrums so as to achieve optimal spectrum profile for the display system.

Referring again to FIG. 1, spatial light modulator 108 comprises an array of individually addressable pixels for spatially modulating the incident light onto or away from projection lens 110 that projects the modulated light onto screen 112 so as to reproduce images. The spatial light modulator may comprise pixels of many different natures, such as reflective and deflectable micromirrors and liquid-crystal-on-silicon (LCOS) devices. The pixels can be operated using binary or non-binary modes. In the binary mode, each pixel is switched between an ON and OFF state. At the ON state, each pixel modulates the incident light onto the projection lens (110). At the OFF state, each pixel modulates the incident light away from the projection lens (110). The ON-state light arrives at the screen (112) so as to construct the desired image; and the OFF-state is recycled by off-state light recycling mechanism 104 and redirected to the spatial light modulator, which will be discussed afterwards. The pixels of the spatial light modulator alternatively can be operated at a non-binary mode, such as an analog mode wherein multiple intermediate states are defined between an ON and OFF state; and the intermediate states may or may not be continuous between the ON and OFF states. In either binary or non-binary operation mode, color and gray images can be produced using a pulse-width-modulation technique, such as those disclosed in “A Pulse Width Modulation Algorithm,” attorney docket number TI-63236; and “A Pulse Width Modulation Algorithm,” attorney docket number TI-63237, both to Russell and filed on the same day as this patent application, the subject matter of each is incorporated herein by reference in its entirety.

OFF-state light recycling mechanism 104 is optically coupled to the propagation path of the off-state light that is modulated from the pixels of the spatial light modulator (108) such that the off-state light from the pixels at the OFF state of the spatial light modulator can be recaptured by the off-state light recycling mechanism. For redirecting the recaptured off-state light back to the pixels of the spatial light modulator, the OFF-state light recycling mechanism has a light exit end that is aligned to the propagation path of the incident light to the pixels of the spatial light modulator.

As an example shown in FIG. 1, incident light 106 from the light source impinges spatial light modulator 108 that modulates the incident light (106) into ON-state light 107 and OFF-state light 114. The ON state light travels towards projection lens 110; and is projected onto screen 112 by projection lens 110. OFF-state light 114 is recaptured by OFF-state light recycling mechanism 104 that is capable of converting the recaptured OFF-state light into incident light 116 and redirecting incident light 116 to illuminate pixels of spatial light modulator 108. At the spatial light modulator, redirected incident light 116 is modulated into ON-state light 117 and/or OFF-state light. The ON-state light (117) is collected by projection lens 110 and the OFF-state light (if any) can be recaptured by the off-state light recycling mechanism (104).

Because the OFF-state light from the spatial light modulator can be recaptured and redirected to the spatial light modulator, this recycling process improves the brightness of images produced on the screen. Such brightness improvement can be mathematically described as brightness gain as expressed in equation 1:

$$I = {I}_{0} G = {I}_{0} \frac{1}{1 - ɛ ( 1 - x )} \qquad ( Eq . 1 )$$

In equation 1, G is the brightness gain due to OFF-state light recycling; I is the illumination intensity of light arriving at the screen including the recycled OFF-state light; and Iₒ is the illumination intensity of light arriving at the screen without OFF-sate light recycling. ε is the OFF-state light recycling efficiency that is defined as the fraction of the OFF-state light that re-illuminates the pixels of the spatial light modulator after a recycling process, compared to the total amount of OFF-state light to be recycled by the recycling process. x is the normalized number of ON-state pixels of the spatial light modulator at a time (e.g. during a bitplane time). Specifically, x can be expressed as equation 2:

$$x = \frac{{N}_{ON}}{{N}_{total}} \qquad ( Eq . 2 )$$

wherein N_{ON} is the number of ON-state pixels at a time; and Nₜₒₜₐₗ is the total number of pixels involved in modulating the incident light. It is noted that Nₜₒₜₐₗ may or may not be the total number of pixels of the spatial light modulator, especially when the spatial light modulator comprises active and inactive pixel areas. Pixels in inactive pixel areas of spatial light modulators are those pixels whose states in image display operations are independent from the data (e.g. bitplane data) derived from desired images; whereas pixels in active pixel areas are those whose states are associated with or determined by the image data.

Recycling efficiency, is primarily determined by the optical design of the off-state light recycling mechanism and the optical coupling of the off-state light recycling mechanism to the display system, particularly to the propagation path of the OFF-state light from the spatial light modulator and the propagation path of the light incident to the spatial light modulator. Ideally, ε is 100%. In practice, ε may be less than 100% due to imperfect optical coupling of the off-state light recycling mechanism to the propagation path of the off-state light from the spatial light modulator and/or to the propagation path of the incident light to the spatial light modulator and/or due to light leakage from imperfect optical design of the off-state light recycling mechanism. To maximize the brightness gain, it is preferred that ε is maximized. In other examples, however, maximizing off-state light recycling may be impeded by other preferred system features, which results in balance between off-state recycling and the preferred features. For example, the off-state light recycling mechanism and/or the system design is desired to be cost-effective or desired to be volume compact or other reasons, poor ε may be selected. In any instances, it is preferred that ε is 10% or more, such as 20% or more, 30% or more, 40% or more, 50% or more, 60% or more, and 70% or more. As an example, table 1 shows the brightness gain achieved from different number of ON-state pixels (which can be converted to the number of OFF-state pixels using equation 2) by assuming that the recycling efficiency ε is 60%.

TABLE 1

| | % of ON-state pixels | | | | | | | | | | |
|---|---|---|---|---|---|---|---|---|---|---|---|
| | 0 | 10 | 20 | 30 | 40 | 50 | 60 | 70 | 80 | 90 | 100 |
| Brightness | 2.5 | 2.17 | 1.92 | 1.72 | 1.56 | 1.43 | 1.32 | 1.22 | 1.14 | 1.06 | 1 |
| gain | | | | | | | | | | | |

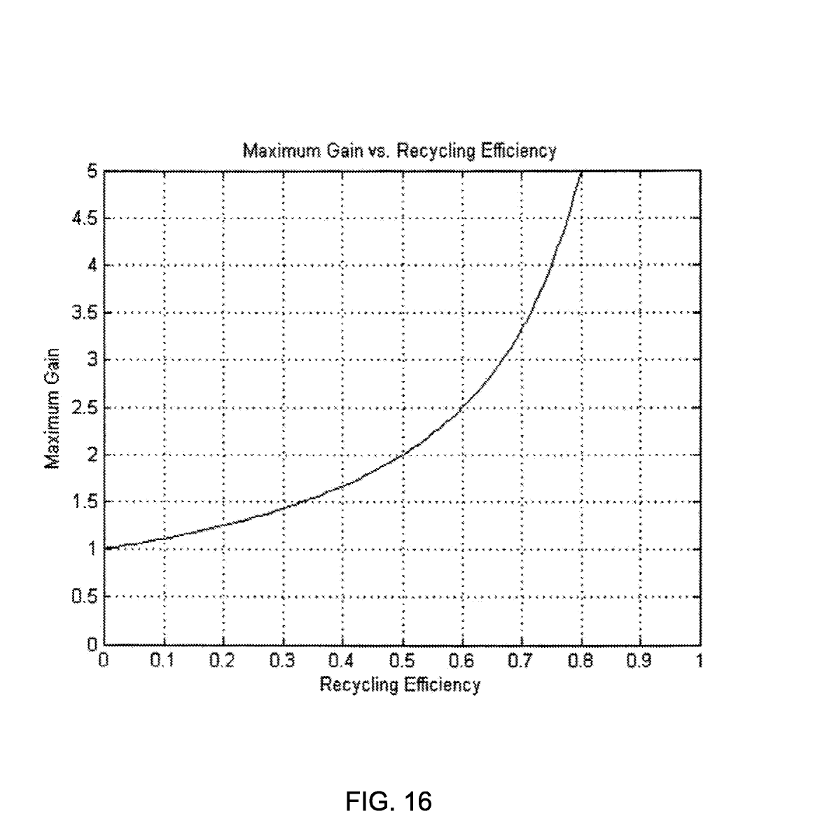

An exemplary variation of the maximum gain with the recycling efficiency is presented in FIG. 16. The diagram in FIG. 16 assumes that all pixels of the spatial light modulator are at the OFF state. Accordingly, equation 1 is reduced to equation 3 with the recycling efficiency being the variable as shown in the following:

$$G = \frac{1}{1 - ɛ} \qquad ( Eq . 3 )$$

As can be seen in FIG. 16, the maximum gain is 1 when the recycling efficiency ε is 0; and the maximum gain is 5 when ε is 0.8.

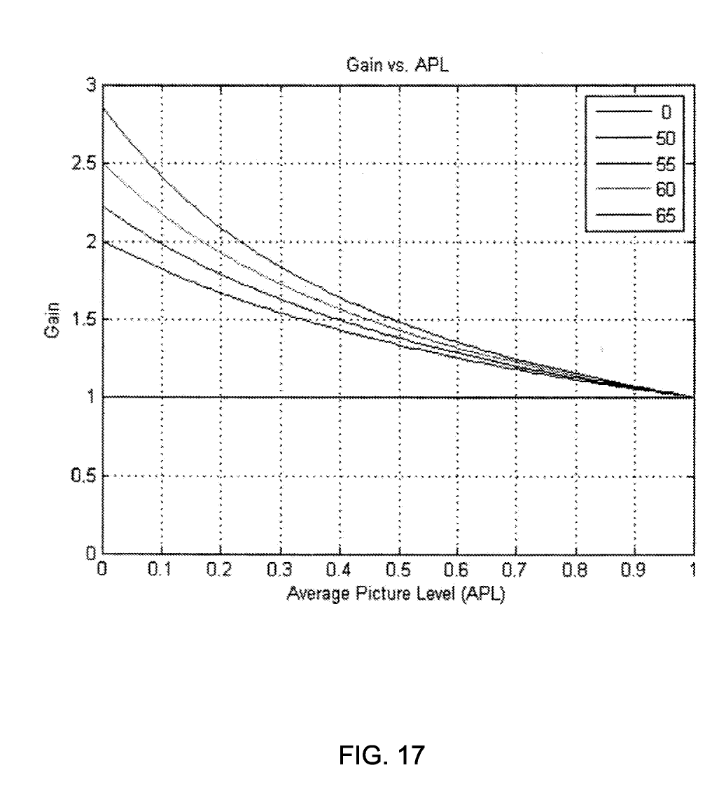

Because the gain is due to the off-state recycling, the amount of gain obtained through off-state recycling depends on the number of off-state pixels of the spatial light modulator during the recycling process. As an example, FIG. 17 presents a diagram of the gain vs. the average-picture-level (APL) in a bitplane with different curves representing different recycling efficiencies. The APL is defined as the fraction of the ON-state pixel data (e.g. the total number of “1”) in a bitplane. As can be seen in FIG. 17, gain increases as APL decreases. A substantially white image has least gain, and thus least brightness boost; whereas a substantially dark image has the most gain, and thus the most brightness boost.

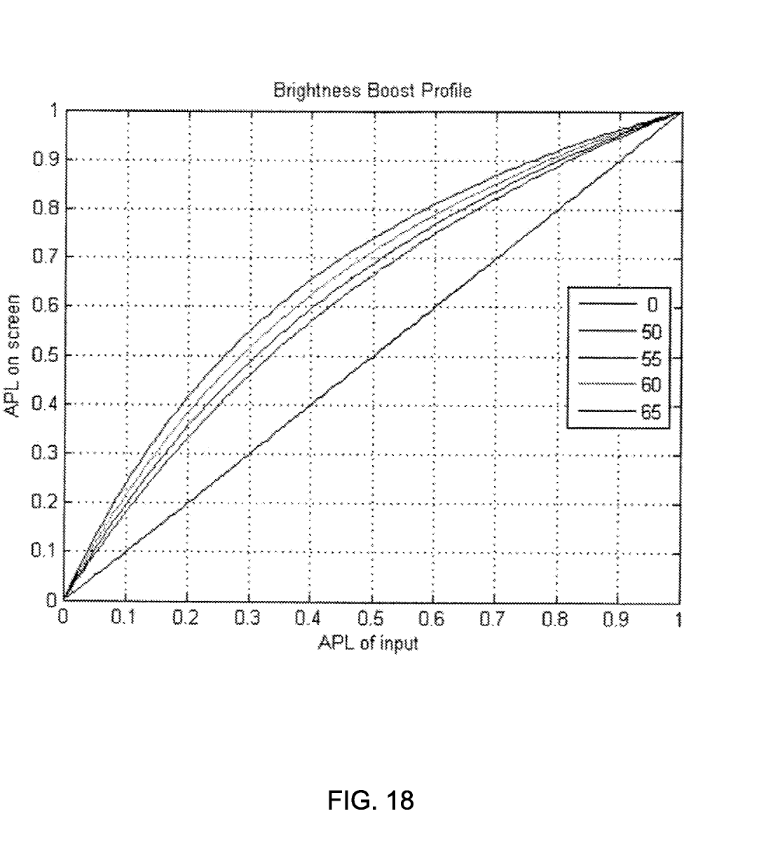

FIG. 18 shows the brightness boost profile represented by the variation of the APL of the produced image on the screen to the APL of the input image. Different curves represent different recycling efficiencies. When the recycling efficiency is zero, the APL on screen is the same as the APL of the input image, as shown in the 45° straight line. As the recycling efficiency increases from zero, the APL on screen deviates from the straight line and evolves into curved lines. Each point on the APL-on-screen curve has a larger y value (APL on screen value) than the y value of the straight line with the same x coordinates (APL of input image). The amplitude of such deviation is determined by the amount of recycled OFF-state light.

In addition to the brightness improvement as discussed above, the off-state light recycling has many other benefits. For example, the off-state recycling can also be used to increase the lifetime of the light source of the imaging system and/or to reduce the power consumption of the imaging system. Specifically, the light source can be operated as a lower power, as compared to imaging operations without off-state light recycling, during imaging operations but without sacrificing the brightness of the reproduced images. Operating the light source at reduced power certainly helps to increase lifetime of the light source, especially solid-state light sources, such as lasers and LEDs. Moreover, reduced power also reduces heat generated by the light source, which in turn increases lifetime of other components in the system by for example, reducing the commonly existing aging effect.

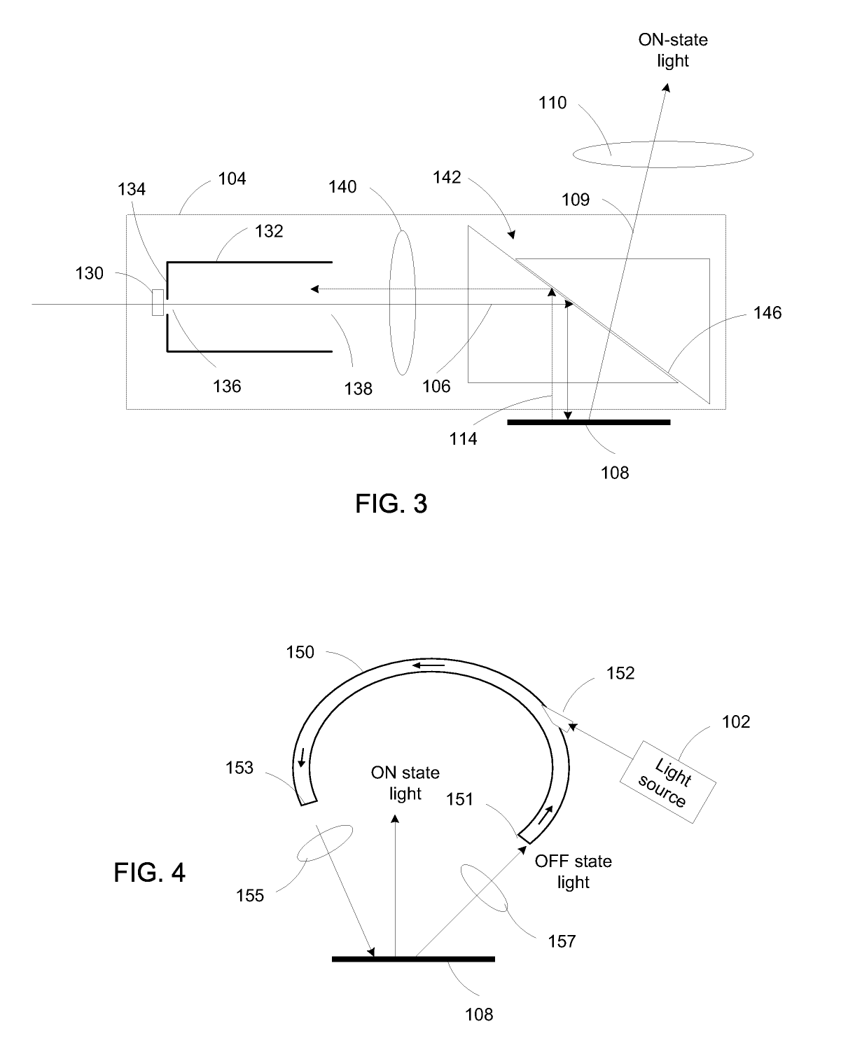

The off-state light recycling mechanism (104) as illustrated in FIG. 1 can be implemented in many possible ways, one of which is schematically illustrated in FIG. 3. Referring to FIG. 3, off-state light recycling mechanism 104 comprises optical diffuser 130, optical integrator 132, condensing lens 140, and prism assembly 142. For illustrating the relative positions of the off-state light recycling mechanism in the imaging system, spatial light modulator 108 and projection lens 110 in FIG. 1 are also shown in the figure.

Optical diffuser 130 is provided herein for homogenizing the light beam incident thereto and transforming the incident light beam, especially narrow-band or narrow-angle light beans from solid-state light emitting devices, into light beams with pre-determined illumination field profiles. A narrow-angle light beam is referred to a light beam with a solid-angle extension of 5 degrees or less, such as 2 degrees or less, 1 degree or less, 0.5 degree or less, and 0.2 degree or less. The homogenization capability of the optical diffuser is enabled by randomly or regularly deployed scattering centers. The scattering centers can be located within the body of the diffuser or in (or on) a surface(s) of the diffuser, which constitute the features responsible for directing the incident light into various spatial directions within the spread of the optical diffuser. Depending upon different locations of the scattering centers, the optical diffuser can be a volume optical diffuser where the scattering centers are within the bulk body of the diffuser, or a surface diffuser where the scattering centers are on the surface of the bulk body of the diffuser. In one example, the optical diffuser can be a surface diffuser, such as a standard engineered diffuser. Even though not required, the optical diffuser can be used when the light source (102 in FIG. 1) employs solid state (or narrow band) light sources. In other examples, such as the light source uses arc lamps, the optical diffuser may be replaced by an optical lens, such as a condensing lens, which is not shown in the figure. A lens combined with smaller angle or spatial diffusers can also be used.

The optical integrator (132) comprises opening 136 formed in end wall 134 of the optical integrator. Side wall 134 has interior surface coated with a reflective layer for reflecting the light incident thereto. In particular, the interior surface of side wall 134 is used to reverse the direction of the incident light such that the off-state light recaptured at the other end (138) of optical integrator 132 can be bounced back to travel towards the spatial light modulator. For this purpose, the reflective layer coated on the interior surface of side wall 134 can be a totally-internally-reflecting (TIR) surface for the OFF-state light.

Opening 136 provided in side wall 134 is designated for collecting the light beams from the light source and directing the collected light towards the spatial light modulator (108). Accordingly, opening 136 is optically aligned to the propagation path of the incident light from the light source, as illustrated in the figure.

Because the opening (136) is provided to collect the incident light and the opening is in the side wall 134 that is designated to bounce the recaptured off-state light, the opening has a preferred dimension such that off-state light leakage from the opening is minimized while collection of the incident light from the light source is maximized. The opening may have a dimension that matched to the dimension of the light incident thereto, such as the dimension of the illumination field of the light beam at the location of side wall 134. As an example, the width or height opening can be 1 mm or less, such as 0.5 mm or less, and 0.2 mm or less. The opening may have any desired shape, such as circle, rectangle, and square.

The other end (138) of optical integrator 132 is designated to capture the off-state light from the spatial light modulator (108). To maximize the capturing of the off-state light, side 138 of optical integrator 132 is substantially open; and the opened portion is optically aligned to the propagation path of the off-state light from the spatial light modulator. In particular, the opening portion of side 138 can be optically aligned to the illumination field of the off-state light at the location of side 138. Even though it is shown in the figure that side 138 and side 136 are substantially parallel and substantially have the same dimension, it is not required. In other examples, side 138 may have a shape and/or a dimension different from that of side 134, in which instance, optical integrator 132 can be tapered or extended from one end (e.g. side 134) to the other (e.g. side 138). Alternatively, optical integrator 132 can be assembled with another optical integrator or a suitable optical element (e.g. lens) such that capturing the off-state light from the spatial light modulator can be maximized.

Optical integrator 132 may have a solid body, such as a body filled with an optical material (e.g. glass) that is transmissive to the incident light. The optical integrator may alternatively comprise a hollowed body, such as an empty space surrounded by multiple reflective walls, one end-side wall 134, and the other end-side wall 138, as discussed above.

The incident light (106), including the light from the light source and the recycled light from the off-state light recycling mechanism, is then guided to the spatial light modulator by condensing lens 140 and prism assembly 142. For properly directing the incident light onto the pixels of the spatial light modulator (108) and spatially separating the ON-state and OFF-state light, the prism assembly employs TIR surface 146. Specifically, TIR surface 146 is optically disposed such that the incident light can be reflected to the spatial light modulator at a pre-determined direction; the off-state light (114) from the pixels at the OFF state can be directed towards side 138 of the off-state light recycling mechanism; and the ON-state light (109) from the spatial light modulator can travel through the TIR surface towards the projection lens (110). These can be achieved by aligning the TIR surface (146) such that the incident light and OFF-state light impinge the TIR surface at incident angles equal to or greater than the critical angle of the TIR surface; whereas the ON-state light impinges the TIR surface at an incident angle less than the critical angle of the TIR surface.

Condensing lens 140 is provided to form a proper illumination field on the TIR surface (146) such that the image of such illumination field projected on the spatial light modulator by the TIR surface has a proper optical profile. For example, the profile has an illumination area matching the pixel area of the spatial light modulator and/or the illumination intensity is substantially uniform across the pixel area. A proper optical profile can be achieved by adjusting the relative positions of condensing lens 140, TIR surface 146, and spatial light modulator 108.

In the example shown in FIG. 3, optical integrator 132 is disposed on the optical path of the light from the light source. A benefit of this configuration is that the recycled off-state light can be re-directed to the spatial light modulator along the same propagation path of the incident light from the light source, thus simplifying the optical design. In other alternative examples, the optical integrator can be disposed such that the optical axis of the optical integrator is not aligned to the incident light path. In this instance, opening 136 may not be formed. Moreover, alternative to using a prism assembly with a TIR surface as shown in FIG. 3, the off-state recycling mechanism can employ an optical fiber or other suitable optical devices. As an example, FIG. 4 schematically illustrates another example of the off-state light recycling mechanism as discussed above with reference to FIG. 1.

Referring to FIG. 4, the off-state recycling in this example is accomplished by using an optical light guide, such as a flexible optical fiber and other suitable optical light guides. The light guide 150 has one end (151) optically coupled to the off-state light to capture the off-state light from spatial light modulator 108. To enhance the optical coupling and thus maximizing the off-state capturing at end 151, optical lens 157 can be provided. Lens 157 can be disposed such that the illumination field of the off-state light at the location of end 151 has a dimension that is substantially equal to or less than the dimension of end 151. In one example, end 151 can be disposed at a focal plane of lens 157.

The other end 153 of optical fiber 150 is optically coupled to spatial light modulator 108 such that the off-state captured at end 151 can be delivered to the spatial light modulator at a pre-determined incident direction. As an alternative feature, optical lens 155 can be disposed between end 153 and spatial light modulator 108 for projecting the off-state light exiting from end 153 onto the pixel area of the spatial light modulator.

In the example as shown in FIG. 4, light from light source 102 can be introduced into the light guide through light injection port 152 formed on the side of the light guide. With this configuration, the recycled off-state light and the light from the light source can propagate along the same optical path towards the spatial light modulator. Of course, the light source and means for conducting the light from the light source onto the spatial light modulator can have other possible arrangements in the display system. It is further appreciated by those skilled in the art that even though it is shown in the figure that the ON-state light is between the off-state light and the incident light onto the spatial light modulator, it is only one of many possible optical arrangements. In one example, the OFF state light path can be located closer to the incident light path than the ON state light path, yet still have 3 distinct light paths. In other examples, the off-state light, on-state light, and the incident light onto the spatial light modulator can be arranged in many other ways, which will be discussed afterwards.

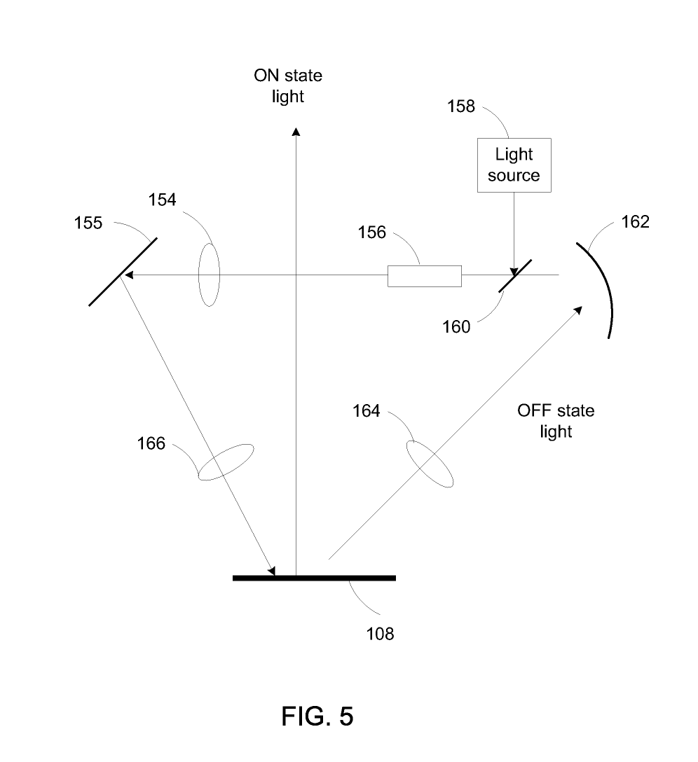

FIG. 5 schematically illustrates yet another exemplary display system employing an off-state light recycling mechanism. Referring to FIG. 5, the display system comprises light source 158, optical filter 160, optical integrator 156, lenses 154, 166, and 164, reflective mirror 155, spatial light modulator 108, and reflector 162.

Light source 158 can be any suitable light emitting devices, such as arc lamps or light source 102 in FIG. 1 as discussed above. Light from the light source is reflected by optical element 160, such as a small mirror or mirrored spot on a larger clear substrate, towards optical integrator 156. The optical integrator can be a standard lightpipe with a solid or hollow body or can be the optical integrator (132) as discussed above with reference to FIG. 3 and 4. The optical integrator (156) directs the incident light from the light source onto reflective mirror 155 through lens 154. After mirror 155, the incident light is incident onto the spatial light modulator through lens 166. The spatial light modulator then modulates the incident light into ON-state and OFF-state light based on image data, such as bitplane data derived from the image to be produced. The ON-state light travels towards a projection lens (not shown in the figure) so as to generate “bright” image pixels on the screen. The off-state light from the spatial light modulator travels towards reflector 162. Reflector 162 in this example comprises a finite focal length so as to focus the off-state light onto the optical integrator (156). To maximize the off-state light capturing, the reflector and the optical integrator can be relatively disposed such that the distance therebetween is substantially equal to or less than the focal length of the reflector. More preferably, the optical integrator and the reflector can be relatively disposed such that the illumination field of the off-state light after the reflector has a dimension at the entrance of the optical integrator equal to or less than the dimension of the entrance. The relative positions of the ON-state light, OFF-state light, and the incident light onto the spatial light modulator as shown in FIG. 5 are only one of many possible examples. Other optical arrangements are also applicable, which will be discussed in the following.

Regardless of different designs and optical arrangements in display systems, it is preferred that the efficiency of recycling the OFF-state light from and back to the spatial light modulator of the display system is maximized. A major factor for maximizing the recycling efficiency is the direction along which the incident light including the recaptured off-state light is directed to the spatial light modulator. When the pixels of the spatial light modulator are individually addressable reflective and deflectable micromirrors, such as the micromirrors of DLP® by Texas Instruments, Inc., operational state angles of the micromirrors may need to be considered. In the following, arrangements of the incident light, off-state light, and the on-state light in the display system will be discussed with reference to particular examples wherein pixels of the spatial light modulator are micromirrors. Other exemplary arrangements particularly useful for spatial light modulators of other types of pixels, such as liquid-crystal-on-silicon (LCOS) will be discussed afterwards. Furthermore, light “overfill” regions outside the active image-forming portion of the spatial modulator array can also be directed towards the recycling mechanism, in a similar way as the off-state pixels of the spatial light modulator, so as to maximize recycling efficiency.

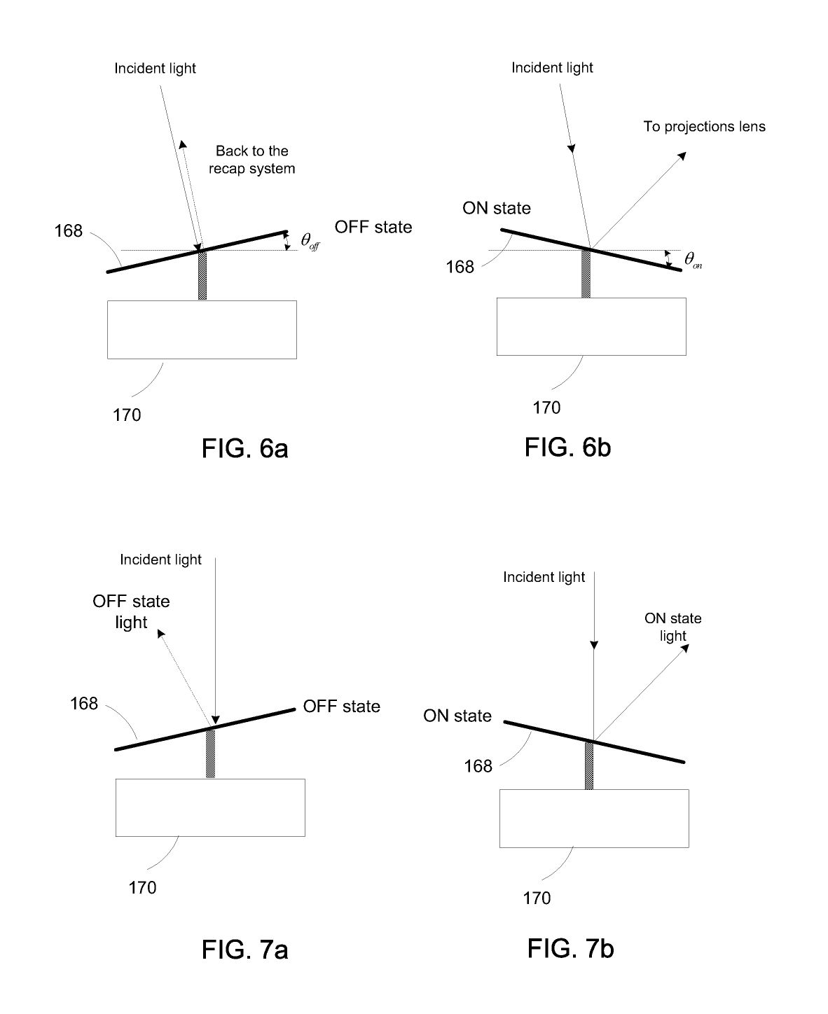

Referring to FIG. 6a and FIG. 6b, an exemplary arrangement of the off-state light and on-state light in relation to the operational state angles of micromirrors of the spatial light modulator are schematically illustrated therein. For simplicity purposes, only one micromirror is shown in each of FIG. 6a and FIG. 6b. In general, the spatial light modulator may comprise any desired number of micromirrors, the total number of which is referred to as the resolution of the spatial light modulator. For example, the spatial light modulator may have a resolution of 640×480 (VGA) or higher, such as 800×600 (SVGA) or higher, 1024×768 (XGA) or higher, 1280×1024 (SXGA) or higher, 1280×720 or higher, 1400×1050 or higher, 1600×1200 (UXGA) or higher, and 1920×1080 or higher, or integer multiples and fractions of these resolutions. Of course, other resolutions are also applicable. It is also noted that the two micromirrors as shown in the figure are not necessarily adjacent micromirrors in the spatial light modulator. Instead, the two micromirrors as shown can be at any locations on the spatial light modulator.

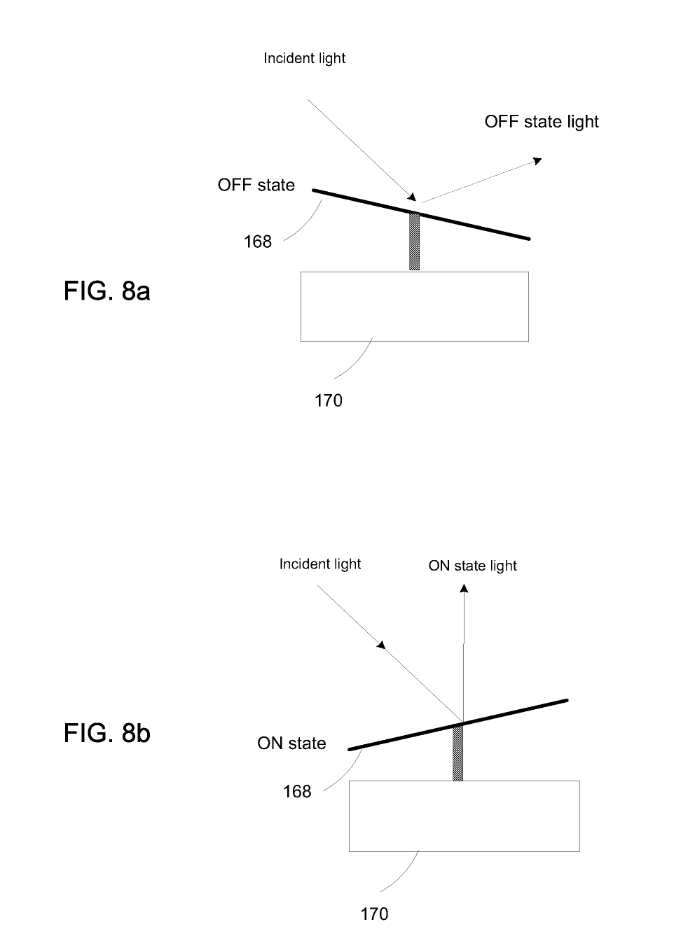

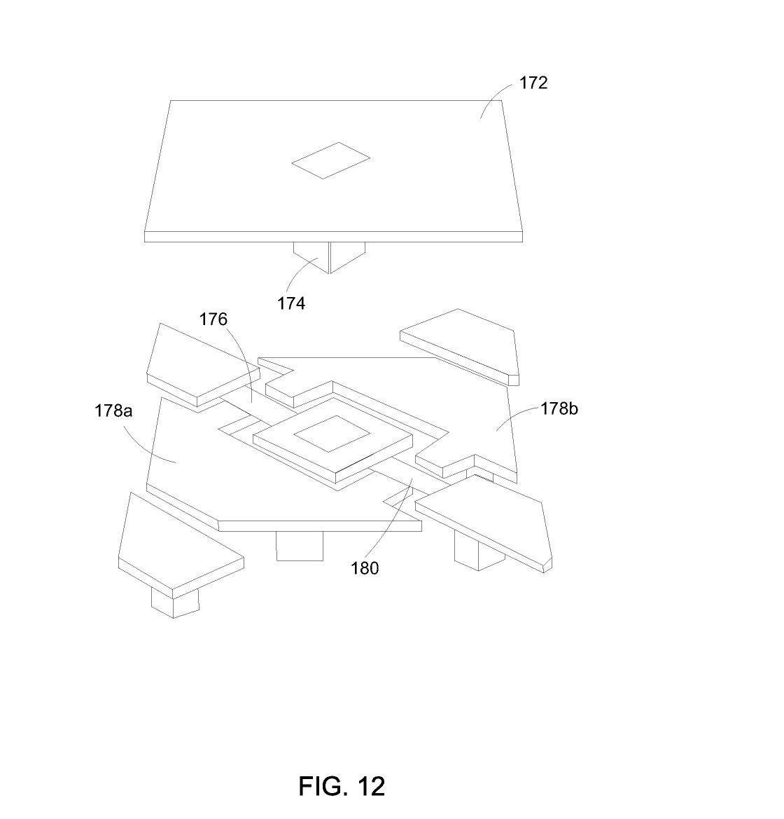

Each micromirror in FIG. 6a and FIG. 6b comprises a reflective and deflectable mirror plate (168) held on substrate 170 by a mechanism such that the mirror plate is capable of moving relative to the substrate. Moving the mirror plate can be accomplished through one or multiple addressing electrodes, which are not shown in the figure. The mirror plate is operated between the ON and OFF states that are respectively associated with the ON-state angle θₒₙ and OFF-state angle θ_{off}. The ON-state and OFF-state angles may have the same absolute values but with opposite directions (θ_{off}=−θₒₙ), which is referred to as “symmetric rotation.” The ON-state and OFF-state angles may have different absolute values, which is referred to as “asymmetric rotation.” Exemplary micromirrors with asymmetric rotation and micromirror arrays (or spatial light modulators) having the asymmetric micromirrors are set forth in U.S. Pat. No. 6,962,419 to Huibers, issued Nov. 8, 2005; and U.S. Pat. No. 6,965,468 to Patel, issued Nov. 15, 2005, the subject matter of each being incorporated herein by reference in its entirety. Either one of the ON-state and OFF-state angles can have an absolute value of 8 degrees or more, such as 10 degrees or more, and 12 degrees or more. As one example, FIG.6a, FIG. 6b, and the following FIGS. 7a to 8b schematically illustrate micromirrors with symmetric rotation. However, optical arrangements of the incident light, off-state light, and on-state light as discussed in the following are also applicable to other types of micromirrors and other types of operational states of micromirrors including micromirrors where either the ON or OFF state is nearly flat, or where the ON and OFF states are tilting in a same or similar direction relative to the flat state. Exemplary micromirrors will be discussed afterwards with reference to FIG. 12.

As illustrated in FIG. 6a and FIG. 6b, it is arranged such that the incident light perpendicularly impinges the mirror plate (168) at the OFF state such that the off-state light from the mirror plate propagates along the direction opposite to the direction of the incident light to the mirror plate so as to be captured by the off-state light recycling mechanism (e.g. the off-state recycling mechanism 104 illustrated in FIG. 1 and FIG. 3), as shown in FIG. 6a. The incident light is reflected by the mirror plate at the ON state towards the projection lens (e.g. projection lens 110 in FIG. 1) so as to produce a “bright” image pixel on the screen.

The incident light can impinge the mirror plate along the normal direction of the mirror plate at a position parallel to the substrate, as illustrated in FIG. 7a. In this instance, the incident light and the off-state light travel along different optical paths. The off-state recycling mechanism, such as those discussed above with reference to FIG. 1, can be aligned to the propagation path of the off-state light. The on-state light from the mirror plate at the ON-state travels towards the projections lens and the screen, as shown in FIG. 7b.

The incident light can be directed towards the mirror plate along other directions, one of which is illustrated in FIG. 8a. The incident light has an acute angle between 0 degree and 90 degrees, exclusive, with the mirror plate at the OFF state. Still, the off-state recycling mechanism can be aligned to the propagation path of the off-state light as illustrated in FIG. 8a. The on-state light from the mirror plate at the ON-state propagates towards the projection lens and the screen, as illustrated in FIG. 8b.

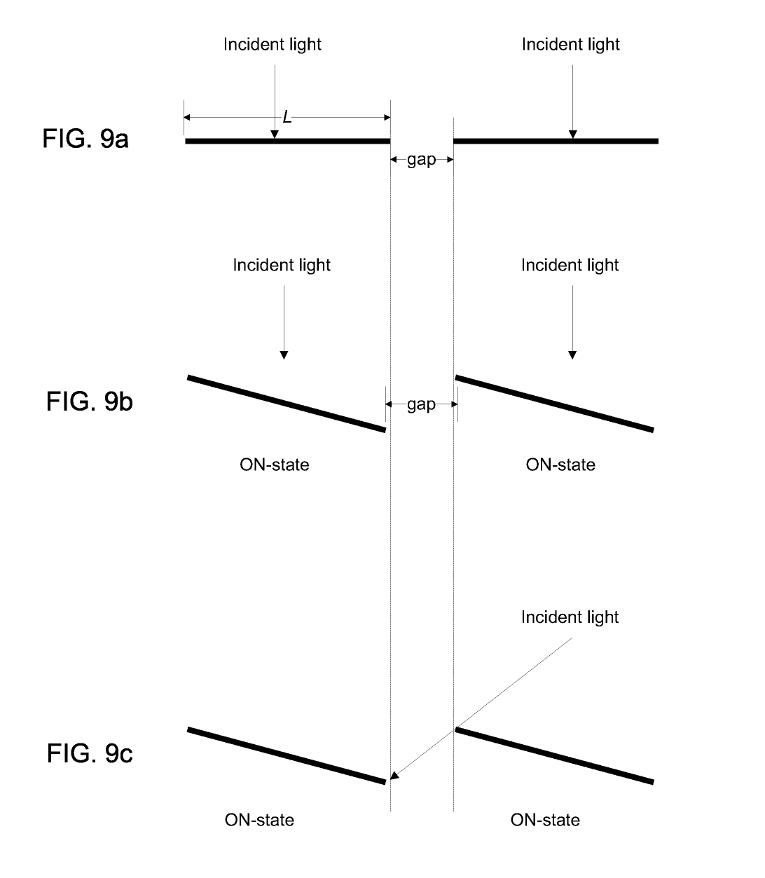

In general, the spatial light modulator comprises an array of micromirrors with the total number in the order of millions or even higher. Gaps between adjacent micromirrors vary with different ON-state and OFF-state angles and with different incident light directions. The gap variation causes different illumination efficiencies of the incident light to the pixels of the spatial light modulator, as demonstrated in FIG. 9a through FIG. 9c.

Referring to FIG. 9a, two mirror plates of adjacent micromirrors in an array are illustrated in their cross sectional views. The two mirror plates each with length L are in the natural resting state—that is a state wherein the mirror plates are parallel to the substrates on which the mirror plates are held as shown in FIG. 7a and FIG. 7b. The gap (Gₒ) is defined as the shortest distance between the two mirror plates. When the incident light is along the direction perpendicular to the mirror plates at the nature resting state, the portion of the incident light falling in the gap is lost; and is not reflected to the screen as the ON-state light or recycled as the OFF-state light. The amount of this lost light portion is proportional to the gap size.

When the mirror plates are rotated to the ON state, as shown in FIG. 9b, the gap (Gap) is larger than the gap in FIG. 9a, which can be expressed as: Gap=Gₒ+[L−L×Cos(θₒₙ)]. Along the incident direction, the portion of the incident light falling into the gap has a larger amount than that falling in the gap illustrated in FIG. 9a. It is further observed that the amount of this portion of the incident light increases with increase of the ON-state angle.

Because the gap and the ON-state angle of the mirror plates are fixed after fabrication, reducing the incident light lost due to gap can be accomplished through selecting the direction of the incident light. As an example, FIG. 9c demonstrates an instance wherein the lost portion of the incident light due to gap is minimized. In this extreme example, the incident light propagates along the direction connecting the opposite edges of the mirror plates at the ON-state such that the gap-size “seen” by the incident light is substantially zero.

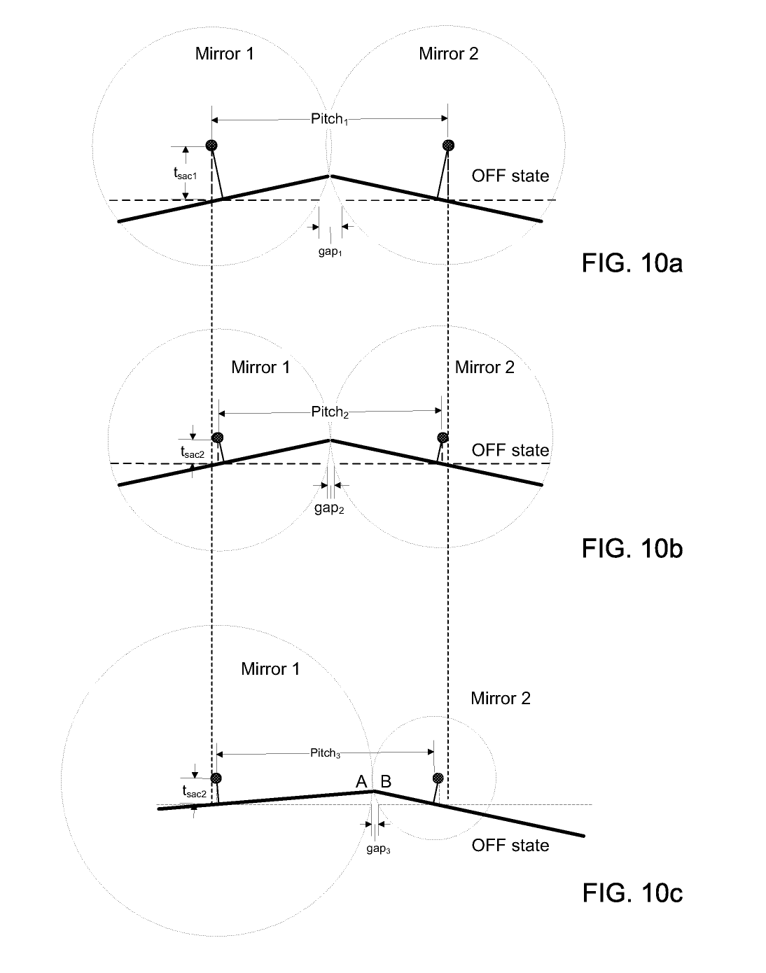

Other than symmetric rotation as illustrated in FIG. 6a through FIG. 9c, the micromirrors can be configured to asymmetric rotation, wherein the absolute values of the ON- and OFF-state angles are different. Micromirrors with asymmetric rotation have many benefits, such as abilities in achieving smaller pitch and gap without adjacent micromirrors impacting each other. As a way of example, FIG. 10a illustrates a cross-sectional view of two adjacent micromirrors, each rotating symmetrically. The solid dark circle in each micromirror represents the rotation axis of the mirror plate. Pitch₁ measures the pitch (equal to the distance between the two rotation axes, which is equivalent to the center-to-center distance) between the adjacent micromirrors. t_{sac} is the distance between the mirror plate and the rotation axis. The trajectory of an end point in each mirror plate is plotted in dotted circle. For demonstrating benefits of asymmetric rotation, it is assumed that the micromirror #2 is fixed and its mirror plate is rotated clockwise to the OFF state angle corresponding to the OFF state of the micromirror. The micromirror #1 can be fabricated to be closer or further away from micromirror 2, thus pitch₁ is variable. In the figure, the micromirror 1 is placed at a position such that during the counter-clockwise rotation of the mirror plate of the micromirror 1 towards the ON state angle, the “right” end of the mirror plate is tangent but without impacting to the “left” end of the mirror plate of the micromirror 2. In this configuration, gap₁ is defined by the two mirror plates of the two adjacent micromirrors when they are “flat” (e.g. parallel to the substrate or non-deflected).

FIG. 10b illustrates a cross-sectional view of two adjacent micromirrors, each rotating symmetrically, while the distance t_{sac2} between the mirror plate and the rotation axis is smaller than that in FIG. 10a, that is t_{sac2}<t_{sac1}. By comparing the gaps and pitches in FIG. 10a and FIG. 10b, it can be seen that gap₂<gap₁, and pitch₂<pitch₁. That is, the smaller t_{sac2} allows for a smaller gap and smaller pitch micromirror array.

The gap and the pitch between adjacent micromirrors in FIG. 10b can be made even smaller by attaching the mirror plate to the hinge asymmetrically, as shown in FIG. 10c. Referring to FIG. 10c, a cross-sectional view of two adjacent micromirrors, each being attached to the hinge such that he mirror plate rotates asymmetrically along the rotation axis, is illustrated therein. Specifically, each mirror plate is attached to the hinge, and the attachment point is positioned closer to one end of the mirror plate than the other. For example, the attachment point of the mirror plate of the micromirror 1 is positioned away from the “right” end A of the mirror plate. And the attachment point of the mirror plate of the micromirror 2 is positioned towards the “left” end B of the micromirror 2. The mirror plates are otherwise identical to those in FIG. 10a and FIG. 10b (e.g. the distance between the mirror plate and the rotation axis in FIG. 10c is the same as that in FIG. 10b). The trajectories of the end A and end B of the mirror plates are plotted in dotted circles. Because the rotations of the mirror plates along their rotation axes are asymmetrical, the trajectory circles of the end A and end B are different. By comparing the gaps and the pitches in FIG. 10b and FIG. 10c, it can be seen that gap₃ and pitch₃ in FIG. 10c are smaller than those in FIG. 10b and FIG. 10a. In particular, gap₃<gap₂<gap₁, and pitch₃<pitch₂<pitch₁. Though a small distance between the mirror plate and the rotation axis and an asymmetric rotation are not required in the present invention, they aid in the ability to achieve small pitch and small gap micromirror arrays—particularly at the lower ends of the dimension ranges in the present invention.

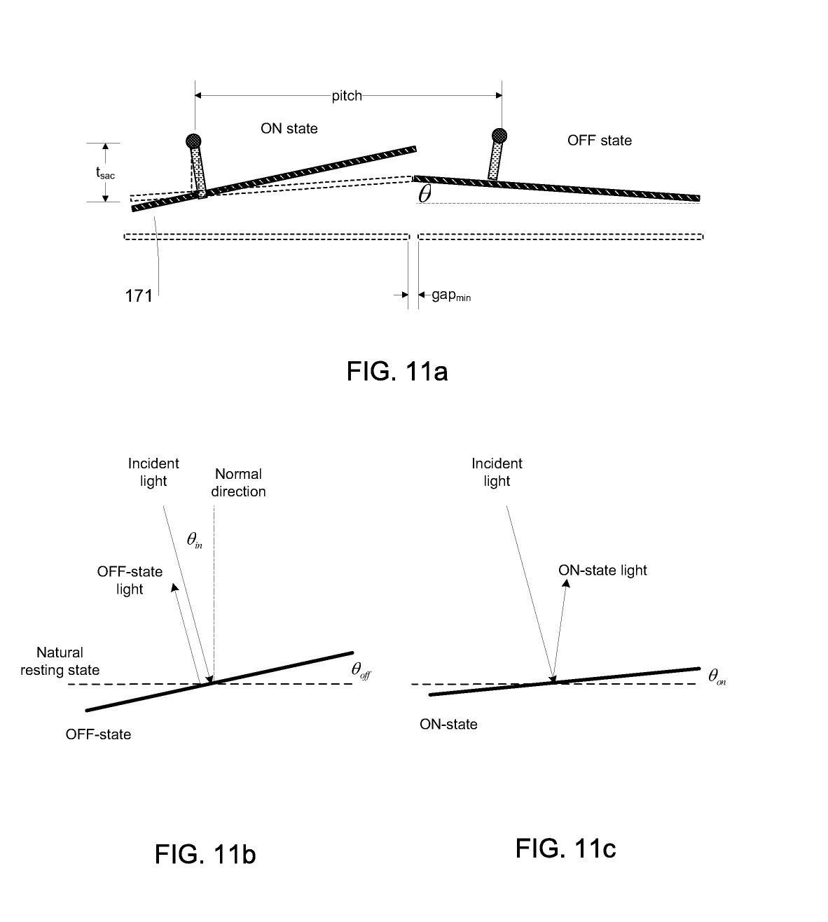

Referring to FIG. 11a, a cross-sectional view of two adjacent micromirrors is illustrated therein. The mirror plates (e.g. mirror plate 171) of the micromirrors each rotates asymmetrically along a rotation axis. Specifically, the mirror plate is attached to a hinge via a hinge contact. The distance between the mirror plate and the hinge is denoted by t_{sac}. As can be seen from the figure, the mirror plate is attached to the hinge asymmetrically. Specifically, the attachment point of the mirror plate to the hinge contact is extended towards one end of the mirror plate so as to enabling the mirror plate to rotate asymmetrically to an ON state or an OFF state. As an example, the ON state angle can be from 8° degrees to 24° degrees, and the OFF state angle can be from −2° degrees to −12° degrees, wherein the “+” and “−” signs represent opposite rotation directions of the mirror plate as shown in the figure.

When micromirrors with asymmetric rotations are used for pixels of spatial light modulators, the incident light can be incident onto the micromirrors with asymmetric rotations in any suitable directions as described above with reference to FIG. 6a through 9c. As a way of example, FIG. 11b and FIG. 11c schematically illustrate an exemplary optical arrangement of the incident light and the mirror plate being operated at asymmetric rotations. Referring to FIG. 11b, the mirror plate is at an OFF-state having an off-state angle θ_{off} to the natural resting state. The incident light is incident to the mirror plate at incident angle θᵢₙ (the angle between the axis of the incident light and the normal direction of the mirror plate at the natural resting state). In this example, the incident angleθᵢₙ, is substantially equal to off-state angle θ_{off}—that is the incident light is perpendicular to the mirror plate at the OFF-state. The OFF-state light reflected from the mirror plate at the OFF-state travels along the propagation path of the incident light but in opposite directions. The ON-state, as illustrated in FIG. 11c, can be defined such that the on-state angle θ_{onf} has the same sign as the off-state angle θ_{off} by a different absolute value than the absolute value of the off-state angle. In another word, the mirror plate rotates to the same direction for both ON- and OFF-states. For example, the OFF-state angle can be from −6 to −24 degrees, more preferably from −10 to −18 degrees, and more preferably around −12 degrees. The ON-state angle can be from −0.5 to −10 degrees, more preferably from −2 to −8 degrees, and more preferably around −6 degrees. In another example, both ON- and OFF-state angles can be positive, in which instance, the incident light angle is preferably positive. For example, the OFF-state angle can be from +6 to +24 degrees, more preferably from +10 to +18 degrees, and more preferably around +12 degrees. The ON-state angle can be from +0.5 to +10 degrees, more preferably from +2 to +8 degrees, and more preferably around +6 degrees; and the incident light is substantially equal to the ON-state angle. In other possible examples, the ON-state angle (or the OFF-state angle) can be substantially zero; while the OFF-state angle (or the ON-state angle) can be a negative value or a positive value. In another example, the absolute value of the ON-state angle θₒₙ can be substantially equal to or less than the absolute value of the OFF-state angle θ_{off}.

For both symmetric rotation and asymmetric rotations, the mirror plate and the incident light can be arranged such that the absolute value of the angle between the ON-state light and the incident light is less than the angle between the OFF-state light and the incident light. For example, the angle between the OFF-state light and the incident light (or the axis of the incident light when the incident light is a cone of light beam) can be substantially zero; while the absolute value of the angle between the ON-state light and the incident light can be greater than zero, such as from 8 to 60 degrees, from 8 to 36 degrees, from 12 to 24 degrees, and from 12 to 18 degrees. Each of the OFF-state and ON-state angles may have a positive or negative sign representing relative rotation directions.

The micromirrors schematically illustrated in FIG. 6a through FIG. 11c may have a wide range of structures, one of which is illustrated in FIG. 12. Referring to FIG. 12, the micromirror comprises reflective mirror plate 172 attached to post 174. The post is attached to deformable hinge 176 such that the mirror plate is capable of rotating. Rotation of the mirror plate is enabled by addressing electrodes 178a and 178b disposed proximate to the mirror plate, as shown in the figure. In operation, electronic fields are established between the mirror plate and addressing electrodes. By varying the electronic fields between the mirror plate and each addressing electrodes, electrostatic torques derived from the electronic fields and applied to the mirror plate can be different. Under the unbalanced electrostatic torques, the mirror plate rotates to the ON-state or the OFF-state.

The micromirror can be formed on a semiconductor substrate having an electronic circuit connected to the addressing electrode for varying the electronic potential of the addressing electrodes. For simplicity purpose, the semiconductor substrate is not shown in the figure. It is noted that the micromirror illustrated in FIG. 12 is only one of many possible micromirror structures. Micromirrors with other structures are also applicable, such as those set forth in U.S. Pat. No. 5,216,537 to Hornbeck issued Jun. 1, 1993, U.S. Pat. No. 5,535,047 to Hornbeck issued Jul. 9, 1996, U.S. Pat. No. 5,999,306 to Atobe issued Dec. 7, 1999, and US patent application 2004/0004753 to Pan, published Jan. 8, 2004, the subject mater of each being incorporated herein by reference in its entirety. In another example, the micromirror can be formed on a substrate that is transmissive to the incident light, as set forth in U.S. Pat. No. 5,835,256 issued Nov. 10, 1998, the subject matter being incorporated herein by reference in its entirety.

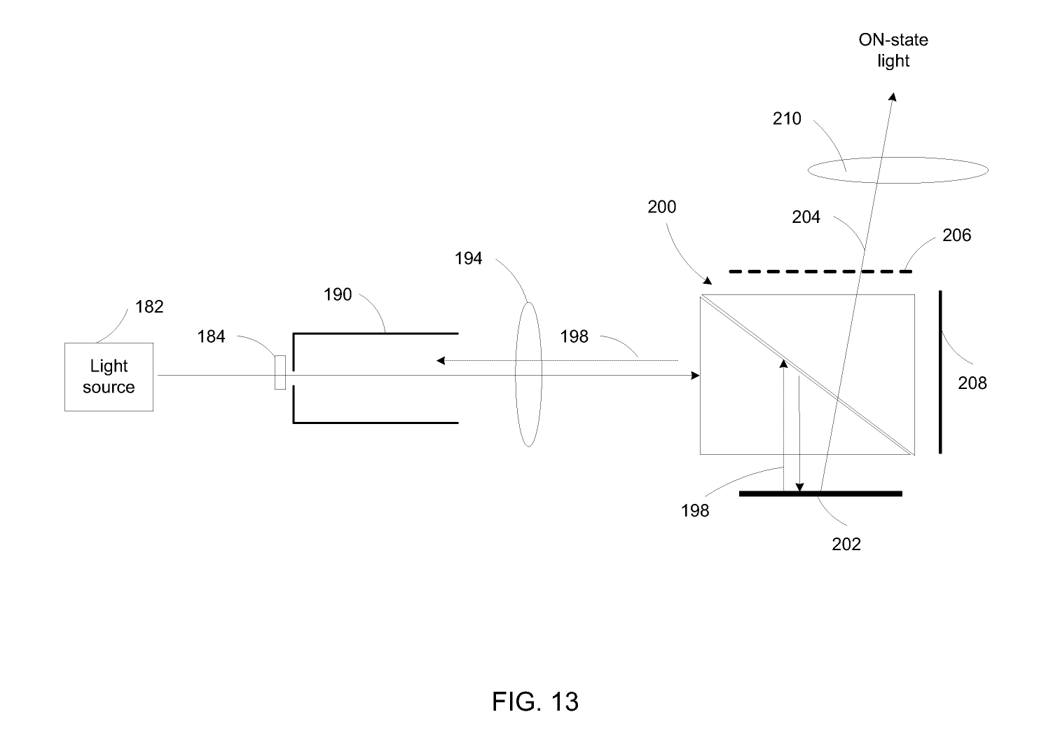

In addition to micromirrors, the off-state recycling mechanism and methods of using the same as discussed above are also applicable to display systems employing other types of spatial light modulators, such as spatial light modulators of LCOS panels, as schematically illustrated in FIG. 13.

Referring to FIG. 13, the exemplary display system comprises light source 182 for providing illumination light for the display system. The light source can be any suitable light sources, such as arc lamps and the light source (102) as discussed above with reference to FIG. 1. The illumination light from the light source is colleted by optical integrator 190, such as the optical integrator 132 discussed above with reference to FIG. 3, through optical diffuser 184, which can be the optical diffuser (130) as discussed above with reference to FIG. 3 or other types of optical diffusers. The illumination light is directed to prism assembly 200, such as a polarizing beam splitter cube through condensing lens 194. The prism assembly then directs the incident light onto the reflective liquid crystal panel (e.g. LCOS panel) 202 using the internal reflective surface of the prism assembly. The LCOS panel modulates the polarization of the incident light into ON-state light of one polarization that travels towards projection lens 210 through clean-up polarizer 206 and OFF-state light 198. The OFF-state light (198) is guided towards the optical integrator 190 through the prism assembly so as to be recaptured by the optical integrator. The recaptured off-state light is then recycled by the optical integrator and redirected to the LCOS panel (202) through the polarizer 192, condensing lens (194), and the prism assembly (200).

As an alternative feature, mirror 208 can be provided for reflecting wrong-polarization light exiting from the side of the prism assembly.

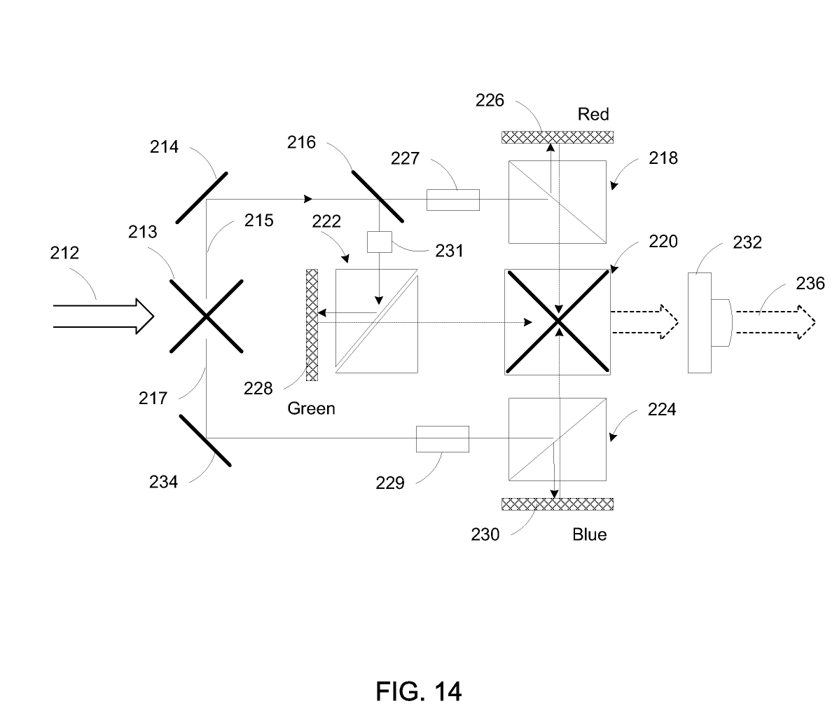

The off-state light recycling mechanism and methods using the same as discussed above are also applicable to display systems employing multiple spatial light modulators, and example of which is schematically illustrated in FIG. 14. Referring to FIG. 14, the display system employs spatial light modulators 226, 228, and 230, each of which can be a spatial light modulator composed of reflective and deflectable micromirrors, LCOS panels, or other types of spatial light modulators. Each spatial light modulator is designated to modulator one color component of the incident light. For example, spatial light modulators 226, 228, and 230 can be respectively designated to modulate red, green, and blue colors of light. It is noted by those skilled in the art that the above assignment and optical arrangement of the spatial light modulators are only one of many possible examples. It should not be interpreted as a limitation. Other variations are also applicable.

In operation, incident light 212 from the light source, such as light source 102 as discussed above with reference to FIG. 1, is split by optical filter assembly 213 into green light component 217 and combination light component 215 of red and green colors. The combination light component (215) is directed by mirror 214 to filter 216 that passes the red light component and stops (reflects) other light components. After filter 216, the combination light (215) is split into red and green color components. The red light component enters prism assembly 218; and the green light component enters into prism assembly 222. Each one of prism assemblies 218 and 222 comprises a reflecting surface, such as the prism assembly 142 as discussed above with reference to FIG. 13. Spatial light modulator 226 then modulate the red light component of the incident light based on the image data (e.g. bitplane data) derived from the red image component of the desired image. The red light component modulated by the ON-state pixels of spatial light modulator 226 (ON-state red light) propagates towards light combiner 220. The light combiner (220) e.g. an X-cube prism comprises cross-positioned filters, one of which reflects the ON-state red light towards projection lens 232. The red light component modulated by the off-state pixels of spatial light modulator 226 (OFF-state red light) is recaptured by optical integrator 227, which can be the same as the optical integrator 132 as discussed above with reference to FIG. 3. The recaptured off-state red light is then redirected to spatial light modulator 226 through prism assembly 218.

The green light component after filter 216 impinges spatial light modulator 228 through prism assembly 222. The ON-state green light, which is the light modulated by the on-state pixels of spatial light modulator 228, travels towards the light combiner (220) through prism assembly 222. The light combiner passes the ON-state green light onto projection lens 232. The OFF-state green light, which is modulated by off-state pixels of spatial light modulator 228, is recaptured by optical integrator 231 and then redirected to spatial light modulator 228. Optical integrator 231 can be the same as the optical integrator 132 as discussed above with reference to FIG. 3.

The blue light component split from the incident light at filter 213 is directed to spatial light modulator 230 through mirror 234 and prism assembly 224. Spatial light modulator 24 modulates the incident blue light component into OF-state blue light and OFF-state blue light. The ON-state blue light travels towards light combiner 220 that redirects the ON-state blue light towards projection lens 232. The OFF-state blue light is recaptured by optical integrator 229 and recycled to spatial light modulator 230.

The light combiner (232) reflects red and blue ON-state light and passes the green ON-state light. The combined red, green, and blue ON-state light (236) is directed to projections lens 232 that projects the combined ON-state light onto a screen so as to generate the desired image.

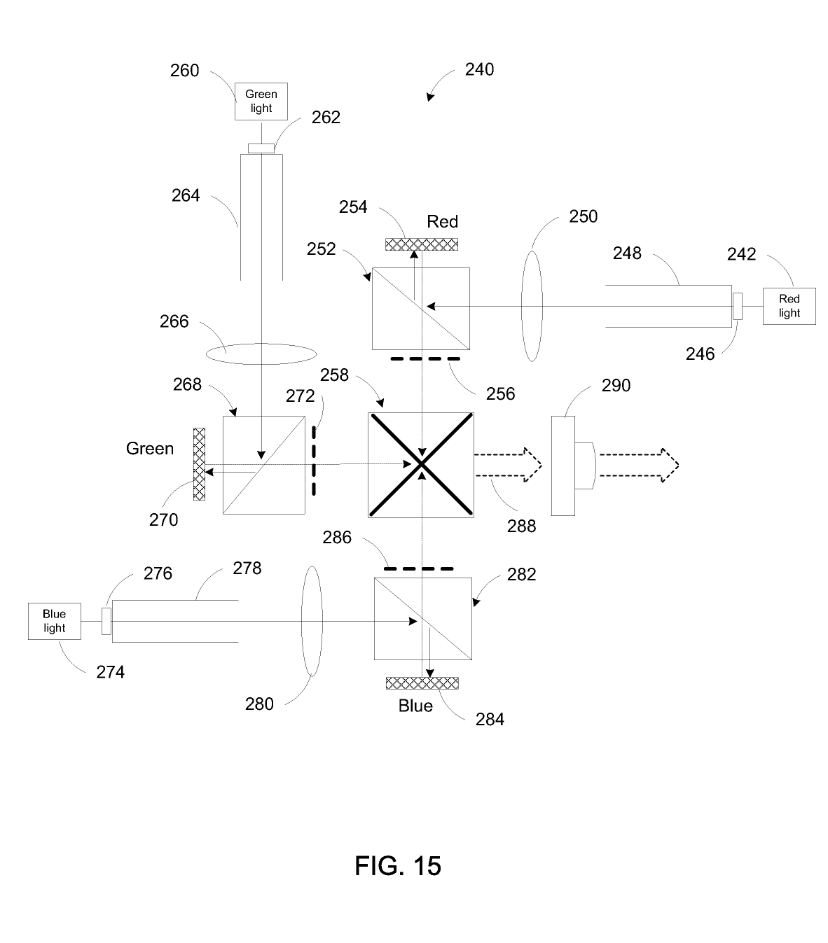

It is noted that the multiple chip display system having off-state recycling mechanisms illustrated in FIG. 14 is only one of many possible examples. The multi-chip display system can employ other types of light recycling mechanisms, one of which is schematically illustrated in FIG. 15.

Referring to FIG. 15, display system 240 employs multiple LCOS panels 254, 270, and 284 for modulating different color components of the incident light. The modulated color components correspond to different color image components of the desired color image, and together form the desired color image on the screen. For demonstration purpose, LCOS panels 254, 270, and 284 are respectively designated for red, green, and blue color components. In many other possible alternatives, less or more than three LCOS panels can be used. For example, an alternative display system may use two LCOS panels with one for modulating a portion of the incident light with a specific spectrum (e.g. red, green, blue, or white); while the other one for modulating the remaining portion of the incident light. In another example where more than three LCOS panels are used, multiple LCOS panels can be used to modulate the primary color components, such as red, green, and blue, or cyan, yellow, and magenta; while another one can be designated to modulate the white color or a combination of the primary colors. Even though all spatial light modulators 254, 270, and 284 are preferably of the same pixels (e.g. micromirrors or LCOS panels), it is not an absolute requirement. Instead, the spatial light modulators 254, 270, and 284 of the display system can be a combination of spatial light modulators having pixels of different physical structures. For example, one of the spatial light modulators can be a LCOS panel; while the other spatial light modulators are micromirrors or other types of pixels capable of modulating the incident light into ON and OFF state light propagating along different directions or with distinguishable optical properties, such as polarizations.

In the example as shown in FIG. 15, each color light component is provided with a separate modulation process that comprises a separate and independent off-state recycling mechanism. Specifically, red light component from light source 242 is directed towards spatial light modulator 254 through optical diffuser 246, optical integrator 248, condensing lens 250, and prism assembly 252. Optical diffuser 246, optical integrator 248, and assembly 252 can be the same as optical diffuser 130, optical integrator 132, and prism assembly 142 illustrated in FIG. 3; and together form an off-state light recycling mechanism for capturing the off-state light from the off-state pixels of spatial light modulator 254 and redirecting the captured off-state light back to the spatial light modulator. The on-state red light from spatial light modulator 254 is directed to beam combiner 258 through polarizer 256, whose operation can be the same as that of polarizer 206 discussed above with reference to FIG. 13.

With the same or similar operation as the red light component, the green light component from light source 260 is directed to spatial light modulator 270 through optical diffuser 262, optical integrator 264, condensing lens 266, and prism assembly 268. Optical diffuser 262, optical integrator 264, and prism assembly 268 can be the same as optical diffuser 130, optical integrator 132, and prism assembly 142 illustrated in FIG. 3; and together form an off-state light recycling mechanism for capturing the off-state light from the off-state pixels of spatial light modulator 270 and redirecting the captured off-state light back to the spatial light modulator. The on-state red light from spatial light modulator 270 is directed to beam combiner 258 through polarizer 272, whose operation can be the same as that of polarizer 206 discussed above with reference to FIG. 13.

Similarly, the blue light component from light source 274 is directed to spatial light modulator 284 through optical diffuser 276, optical integrator 278, condensing lens 280, and prism assembly 282. The optical diffuser, optical integrator, and prism assembly can be the same as optical diffuser 130, optical integrator 132, and prism assembly 142 illustrated in FIG. 3; and together form an off-state light recycling mechanism for capturing the off-state light from the off-state pixels of spatial light modulator 284 and redirecting the captured off-state light back to the spatial light modulator. The on-state red light from spatial light modulator 284 is directed to beam combiner 258 through polarizer 286, whose operation can be the same as that of polarizer 206 discussed above with reference to FIG. 13.

The modulated red, green, and blue light components are combined into modulated light 288 at beam combiner 258; and the combine light is projected onto the screen by projection lens 290.

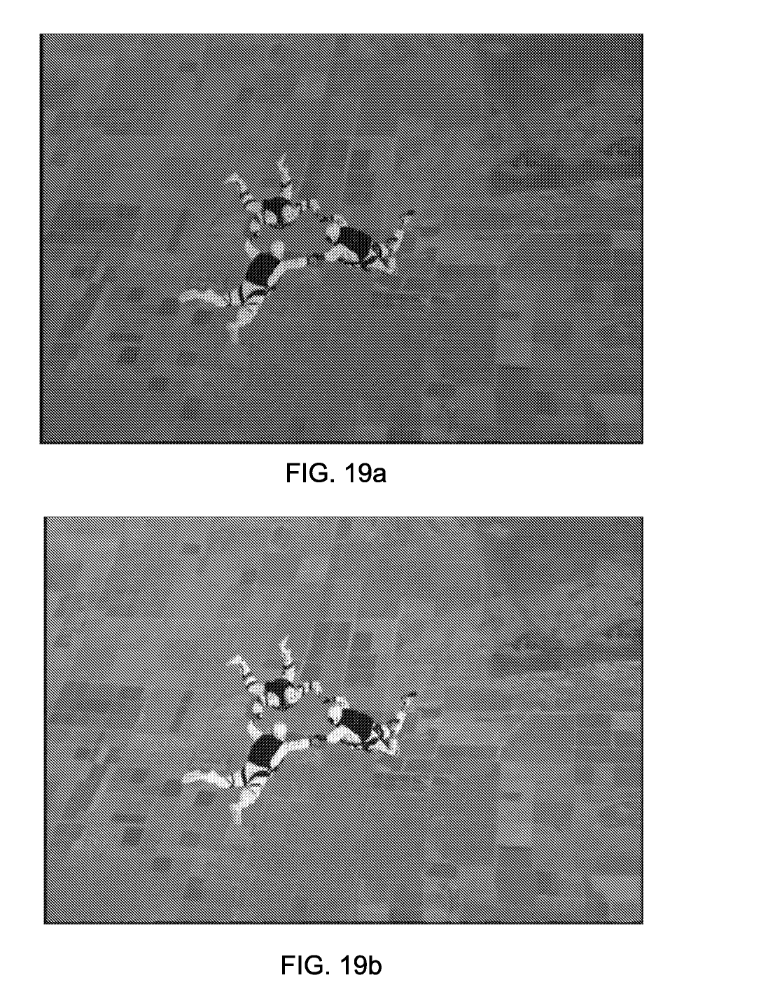

As an example, FIG. 19a and FIG. 19b show two pictures to demonstrate the effect of the brightness boost. Specifically, the picture in FIG. 19a is produced by a display system with substantially zero off-state recycling efficiency. The picture in FIG. 19b is produced by the same display system with non-zero off-state recycling efficiency.

It will be appreciated by those of skill in the art that a new and useful off-state light recycling mechanism and a method of using the same in imaging systems have been described herein. In view of the many possible embodiments, however, it should be recognized that the embodiments described herein with respect to the drawing figures are meant to be illustrative only and should not be taken as limiting the scope of what is claimed. Those of skill in the art will recognize that the illustrated embodiments can be modified in arrangement and detail. Therefore, the devices and methods as described herein contemplate all such embodiments as may come within the scope of the following claims and equivalents thereof.

1. A method for use in a display system that employs a spatial light modulator that comprises an array of individually addressable pixels, the method comprising:
directing a light beam to the pixels of the spatial light modulator;
modulating the light beam into a first portion of light and a second portion of light by the spatial light modulator;
directing the first portion onto a display target; and directing the second portion of light so as to be recycled; and
recycling the second portion of light back to the pixels of the spatial light modulator.

2. The method of claim 1, wherein the step of recycling the second portion of light further comprises:
capturing the second portion of light by using an optical integrator that comprises a substantially open end.

3. (canceled)

4. The method of claim 2, wherein the optical integrator comprises an opening formed on a side wall of the end of the optical integrator; and wherein the side wall has an interior surface that is covered by a reflective layer for reversing a propagation direction of the second portion of light inside the optical integrator.

5. (canceled)

6. (canceled)

7. The method of claim 1, wherein the light beam is a narrow-band light beam produced by a solid-state light emitting device of the light source; and wherein the solid-state light emitting device is a laser emitting device or a light emitting-diode.

8. (canceled)

9. (canceled)

10. The method of claim 2, further comprising:
directing the first and second portions of light to a prism assembly that comprises a TIR surface;
reflecting the second portion of light by the TIR surface to the optical integrator;
passing the first portion of light by the TIR surface to a projection lens so as to generate a bright image pixel on a screen;
projecting the second portion of light passing through the prism assembly onto the open side of the optical integrator by using an optical lens such that an illumination field of the second portion of light at said open end of the optical integrator has an area that is substantially equal to or less than the area of said open end.

11. (canceled)

12. The method of claim 1, wherein the step of recycling the second portion of light further comprises:
capturing the second portion of light by using the an optical fiber, wherein the optical fiber comprises one end optical coupled to a propagation path of the off-state light from the spatial light modulator and the other end optically coupled to a propagation path of the light beam incident towards the spatial light modulator; and
injecting the light beam from the light source into the optical fiber through an injection window that is formed on an arm of the optical fiber.

13. (canceled)

14. The method of claim 1, wherein the step of recycling the second portion of light further comprises:
reflecting the second portion of light by a reflector with a finite focal length to a mirror; and
reflecting the second portion of light from the reflector by the mirror towards the spatial light modulator.

15. (canceled)

16. The method of claim 1, wherein the pixels of the spatial light modulator are reflective and deflectable micromirrors; and wherein the incident light and the recycled second portion of light are incident onto the micromirrors along a direction that is perpendicular to the micromirrors at a position wherein the incident light is modulated into the second portion of light.

17. (canceled)

18. The method of claim 1, wherein the pixels of the spatial light modulator are reflective and deflectable micromirrors; wherein the incident light and the recycled second portion of light are incident onto the micromirrors along a direction that is perpendicular to the micromirrors at a natural resting state.

19. The method of claim 1, wherein the pixels of the spatial light modulator are reflective and deflectable micromirrors; wherein the incident light and the first portion of light from the pixels of the spatial light modulator has a first angle; and the incident light and the second portion of light from the pixels of the spatial light modulator has a second angle; and wherein the second angle has an absolute value less than the absolute value of the first angle.

20. The method of claim 16, wherein the incident light has an incident angle to a normal direction of the mirror plate at the natural resting state; and wherein said incident angle has an absolute value of from 0 to 24 degrees.

21. (canceled)

22. The method of claim 16, wherein the incident light has an incident angle to a normal direction of the mirror plate at the natural resting state; and the first portion of light from the spatial light modulator has a first reflective angle to said normal direction, wherein the first reflective angle is from 0 to 12 degrees.

23-26. (canceled)

27. The method of claim 1, wherein the pixels are operated at a digital mode or an analog mode.

28. A display system, comprising:
a light source capable of providing light;
a spatial light modulator having an array of pixels for modulating the light into a first portion of light and a second portion of light such that the first portion of light can be directed to a display target by a projection lens, while the second portion of light is directed such that said second portion of light is capable of being recycled; and
an off-state recycling mechanism having a first portion that is optically coupled to a propagation path of the a first portion of light from the spatial light modulator for capturing the second portion of light; and a second portion positioned such that the captured second portion of light is capable of being delivered back to the spatial light modulator.

29. The display system of claim 28, wherein said first portion of off-state light recycling mechanism is a an open side of an optical integrator with said open side facing the second portion of light from the spatial light modulator; wherein said second portion of the off-state light recycling mechanism is another side of the optical integrator with said another side having an interior surface that is covered by a light reflective layer; and wherein the off-state light recycling mechanism further comprises:
a prism assembly having a TIR surface, wherein the TIR surface is positioned such that the ON-state light is capable of passing through the TIR surface, whereas the OFF-state light is capable of being reflected towards the open end of the optical integrator and
wherein said another side of the optical integrator comprises an opening with a dimension that is substantially equal to or less than a characteristic dimension of the light from the light source at the location of said opening.

30-32. (canceled)

33. The display system of claim 29, further comprising:
an optical diffuser disposed between said opening and the light source.

34-36. (canceled)

37. The display system of claim 29, wherein the spatial light modulator comprises an array of micromirrors each of which comprises a reflective and movable mirror plate or wherein the spatial light modulator is a liquid-crystal-on-silicon panel.

38-42. (canceled)

43. The display system of claim 29, wherein the light source comprises a solid state light emitting device, and wherein the solid-state emitting device is a laser emitting device or a light-emitting-diode.

44-53. (canceled)

54. A method for reproducing an image, comprising:
providing a plurality of light components having different characteristic spectrums that fall in a plurality of visible light ranges;
directing the light components to a plurality of spatial light modulators such that at least two of the spatial light modulators are illuminated by color light beams whose spectrums fall in different color ranges, wherein each spatial light has an array of pixels capable of being operated at a first state and a second state;
directing the light from the pixels at the first state onto a display target, and the light from the pixels at the second state to be recycled; and
recycling the light from the pixels at the second state from at least one of the plurality of spatial light modulators back to said at least one of the plurality of spatial light modulators.

55. The method of claim 54, wherein the step of recycling further comprises:
capturing said light from the pixels at the second state using an optical integrator having an open end and a reflective side wall at the other end; and
re-directing the captured light from the pixels at the second state back to said spatial light modulator.

56-77. (canceled)
